(19) United States
(12) Patent Application Publication
(10) Pub. No.: US 2025/0297046 A1
(43) Pub. Date: Sep. 25, 2025

(54) SELF-HEALING POLYMERS

(71) Applicant: Vrije Universiteit Brussel, Brussel (BE)

(72) Inventors: Aleix Costa Cornellà, Brussel (BE); Joost Brancart, Brussel (BE); Seppe Terryn, Brussel (BE); Guy Van Assche, Brussel (BE); Bram Vanderborght, Brussel (BE)

(73) Assignee: Vrije Universiteit Brussel, Brussel (BE)

(21) Appl. No.: 18/861,739

(22) PCT Filed: Apr. 26, 2023
(86) PCT No.: PCT/EP2023/060935

§ 371 Date: Oct. 30, 2024

(30) Foreign Application Priority Data
May 5, 2022 (EP) 22171868.7

(51) Int. Cl. C08F 283/01; C08K 5/13

(52) U.S. Cl. CPC C08F 283/01; C08K 5/13

(57) ABSTRACT

The present invention relates to self-healing polymers and uses thereof in various domains, such as additive manufacturing and robotics. Furthermore, the present invention relates to a method for preparing said self-healing polymers, and to compositions and structures comprising said polymers.

### FIELD OF THE INVENTION

The present invention relates to self-healing polymers and uses thereof in various domains, such as additive manufacturing and robotics. Furthermore, the present invention relates to a method for preparing said self-healing polymers, and to compositions and structures comprising said polymers.

### BACKGROUND TO THE INVENTION

Any material which is applied in any type of application domain is susceptible to a certain degree of degradation over time. This degradation may be caused for instance by environmental conditions, incurred damage during operation or other external factors. Depending on the type of application, different types of materials will be suitable and are generally selected in function of their material-specific properties (e.g. weight, rigidity, flexibility, stability, conductive properties, porosity). When materials are damaged (e.g. material cracks, ruptures, cuts, scratches), an external intervention is often necessary to repair the damage. If the damage is too severe or repairing the damage would be disadvantageous (e.g. due to high costs, prolonged repair times), partial or full replacement of the materials might be necessary. All in all, materials might be damaged, and repair might be necessary over time for the materials and parts made thereof to remain functional. Therefore, materials which could intrinsically correct damage could prevent costs and would be highly beneficial, especially in those areas where parts are frequently damaged or areas where repair or maintenance is difficult or impossible.

Robotics, and more specifically the application of soft grippers, is a prime example of an area susceptible to damage during use. Soft grippers can be deployed in agriculture and food packaging, which is made possible by embodied intelligence, being the role of an agent's body in generating behavior which allows control to be outsourced to a smart design. When used for fruit and vegetable picking, these soft grippers come in close contact with sharp objects (e.g. sharp twigs, thorns, plastic or glass). As a result, macroscopic damage (e.g. perforations, cuts and ruptures) occurs over time and negatively impacts the performance of these grippers. Usually, these soft grippers are produced out of relatively cheap materials, such as elastomers (e.g. silicones, polyurethanes), resulting in replacement rather than repair of damaged grippers. However, this requires time-consuming and costly human intervention as well as a considerable amount of new resources. Moreover, it creates waste material over time, having an important ecologic impact. Because of those downsides, the use of self-healing materials can be seen as promising alternatives to minimize external intervention and allow the damaged materials to be repaired, making material replacement superfluous.

Robots will also be used in remote applications, like search-and-recovery or environmental investigations in (aero) space or marine environments, where it becomes difficult to repair or replace a damaged part. Soft robots can bend, stretch, and twist around obstacles, which gives them the advantage of being safer, but the disadvantage of being harder to control due to their infinite number of degrees of freedom.

Self-healing materials already exist today and have the ability to repair damage without the need to replace these materials. However, a number of drawbacks are known. For extrinsic healing systems, relying on the encapsulation of a healing agent, the healing action may often take place a limited number of times only at the same damage location. Also, the healing mechanism is often unsuitable for healing damages of a considerable size. Furthermore, these healing mechanisms are only available in stiff materials, not offering the flexibility that is highly beneficial, for instance, in soft gripper construction. In many intrinsic healing systems, the material strength often is insufficient for the production of larger 2D or 3D structures having sufficient strength and retention of structural integrity.

A specific type of self-healing materials is the Diels-Alder (DA) polymer network, which provides a solution to most of the aforementioned drawbacks. This network is based on a reversible Diels-Alder reaction between functional diene (e.g. furan) and dienophile (e.g. maleimide) groups, effectuating the self-healing characteristics. The process of crosslinking within these polymers is the most important aspect of the specific self-healing characteristics of the Diels-Alder-based polymers which is based on strong covalent bonding, allowing the production of 1D, 2D or 3D structures having sufficient mechanical strength even after self-healing. Previous work of the applicant (EP 20192135.0) has led to the development of a novel Diels-Alder-based polymer network having self-healing capabilities even at room temperature and below, without the need for external intervention.

However, as recently stated by Hawkes et al. (Sci. Robot. 2021, 6, eabg6049), there are some key challenges that must be overcome before soft robotics can be widely adopted, with sustainability being one of those challenges. Currently, soft robots do not offer a sustainable solution as (i) the materials from which they are manufactured are fossil-based, and (ii) in addition are usually made from chemically crosslinked materials that have a poor recyclability and biodegradability. The key to a successful sustainable design relies on starting with a good selection of materials. For this reason, as Kaltenbrunner et al. (Adv. Mater. 2021, 33, 2004413) suggested in their review, the field of soft robotics and materials science should advance together, both on the development of new materials that contribute to a more sustainable future, and on the modification of the existing materials, reducing their ecological footprint. The dependence of soft robotics on fossil-based, poorly degradable polymeric materials presents a clear environmental problem. Even though the production capacity of bioplastics is growing at a considerable pace, from around 2.11 million tons in 2018 to 2.62 million tons in 2023, they account for less than 1% of the 335 million tons of plastic produced annually. Moreover, the use of renewable raw materials mainly targets resource issues, but not necessarily waste issues.

In literature, there have been several attempts to improve the sustainability of self-healing Diels-Alder networks. Yoshie et al. (Polym. Degrad. Stab. 2019, 161, 13) developed bio-based polyesters that with mild heating at 50° C. for 5 days can recover a stress at fracture up to 18 MPa. Gandini et al. (Eur. J. Lipid Sci. Technol. 2018, 120, 1700091) focused on the use of vegetable oils, highlighting the potential use of several types of oils and furan monomers for self-healing applications. Feng et al. (ACS Appl. Polym. Mater. 2019, 1, 169) functionalized epoxidized natural rubber with furfuryl amine to obtain a material that can be reprocessed and heals 87% upon heating at 150° C. Recently, Wu et al. (Green Chem. 2021, 23, 552) reported the synthesis of a self-healing CO₂-based polyurethane-urea DA that self-heals with an efficiency up to 94% upon heating to 120° C. for 10 min and 60° C. for 24 h. In all these cases, the focus is put solely on one or two sustainability aspects while other aspects are neglected.

It is therefore an object of the current invention to address these problems from a more holistic perspective, by providing novel sustainable self-healing polymers, thereby optimizing renewability, biodegradability, and recyclability of these polymers as a whole.

### SUMMARY OF THE INVENTION

According to a first aspect, the present invention provides a Diels-Alder-based polymer comprising the reaction product of a polymaleimide monomeric unit and a furan-functionalized prepolymer; wherein said furan-functionalized prepolymer is characterized in having a prepolymer backbone comprising a substituent having a central moiety according to formula (I)

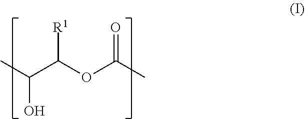

wherein R¹ is —H; wherein at least one furan-functionalized sidechain is connected to said central moiety; and wherein said prepolymer backbone is based on a polyester.

According to an embodiment of the invention, said furan-functionalized sidechain is directly connected to said central moiety, and has a structure according to formula (II)

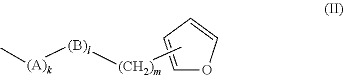

wherein
A is selected from —C₁₋₆alkyl-, —C₂₋₆alkenyl-, and —C₁₋₆alkyl-O—; wherein each of said —C₁₋₆alkyl-, —C₂₋₆alkenyl-, and —C₁₋₆alkyl-O— is optionally and independently substituted with from 1 to 3 substituents selected from -halo, —OH, —C₁₋₆alkyl, —C₁₋₆alkenyl, and —O—C₁₋₆alkyl;
B is selected from —C(O)O—, and —O(O)C—;
k is an integer selected from: 0, 1, 2;
l is an integer selected from: 0, 1; and
m is an integer selected from: 0, 1, 2, 3, 4, 5.

According to an embodiment of the invention, said central moiety of formula (I) is directly connected to the prepolymer backbone.

According to an embodiment of the invention, said central moiety of formula (I) is connected to the prepolymer backbone through a linker structure according to formula (III)

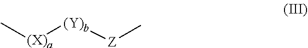

wherein
X is selected from —C₁₋₆alkyl-, and —C₂₋₆alkenyl-; wherein each of said —C₁₋₆alkyl-, and —C₂₋₆alkenyl- is optionally and independently substituted with from 1 to 3 substituents selected from -halo, —OH, —C₁₋₆alkyl, —C₁₋₆alkenyl and —O—C₁₋₆alkyl;
Y is selected from —C(O)O—, and —O(O)C—;
Z is selected from —O—, and —C(O)O—;
a is an integer selected from: 0, 1, 2; and
b is an integer selected from: 0, 1.

According to an embodiment of the invention, said polymaleimide monomeric unit and said furan-functionalized prepolymer both comprise a functionality of at least 2, and wherein the sum of the functionalities of both said polymaleimide monomeric unit and said furan-functionalized prepolymer is at least 4.6.

According to an embodiment of the invention, the maleimide-to-furan stoichiometric ratio between said polymaleimide monomeric unit and said furan-functionalized prepolymer ranges from 1 to 0.25, preferably from 1 to 0.6.

According to an embodiment of the invention, said polymaleimide is selected from the list comprising 1,1′-(methylenedi-4,1-phenylene) bismaleimide, N,N′-(1,4-phenylene) dimaleimide, N,N′-(1,3-phenylene)dimaleimide, bismaleimide, and the like.

According to another aspect, the present invention provides a composition comprising a Diels-Alder-based polymer as defined herein.

According to an embodiment of the invention, said composition further comprises a radical scavenger. According to a particular embodiment of the invention, said radical scavenger is selected from the list comprising hydroquinone butylated hydroxytoluene, 4-tert-butylcatechol, methyl-p-benzoquinone, and the like.

According to another aspect, the present invention provides a method of preparing a Diels-Alder-based polymer as defined herein, said method comprising the step of preparing a composition comprising a polymaleimide monomeric unit and a furan-functionalized prepolymer.

According to yet another aspect, the present invention provides uses of Diels-Alder-based polymers or compositions of the present invention.

According to a further embodiment, the present invention provides the use of Diels-Alder-based polymers or compositions, as self-healing material.

According to a further embodiment, the present invention provides the use of Diels-Alder-based polymers or compositions, in robotics or biomedicine.

According to a further embodiment, the present invention provides the use of Diels-Alder-based polymers or compositions, in the manufacturing of 1D, 2D or 3D structures, more particular in the manufacturing of robotic components.

According to a further embodiment, the present invention provides the use of Diels-Alder-based polymers or compositions, in filament extrusion, extrusion-based printing techniques, selective laser sintering, injection molding, compression molding, casting, soft lithography, and the like. According to a particular embodiment of the invention, said extrusion-based printing techniques are selected from the list comprising fused filament fabrication, direct ink writing, and the like.

According to another aspect, the present invention provides a 1D, 2D or 3D structure comprising Diels-Alder-based polymers or compositions, as defined herein.

### BRIEF DESCRIPTION OF THE DRAWINGS

With specific reference now to the figures, it is stressed that the particulars shown are by way of example and for purposes of illustrative discussion of the different embodiments of the present invention only. They are presented in the cause of providing what is believed to be the most useful and readily description of the principles and conceptual aspects of the invention. In this regard, no attempt is made to show structural details of the invention in more detail than is necessary for a fundamental understanding of the invention. The description provided with the drawings makes apparent to those skilled in the art how the several forms of the invention may be embodied in practice.

FIG. 1 shows a chemical Diels-Alder reaction scheme between a furan A and maleimide B group resulting in a Diels-Alder reaction product C according to an embodiment of the current invention.

FIG. 2 shows an illustration of hydrogen bonding between different central moieties according to embodiments of the current invention.

FIG. 3 shows the ¹H NMR spectrum of Castor oil (CO), maleinized Castor oil (mCO) and furan-functionalized maleinized castor oil (FmCO).

FIG. 4 shows the ¹H NMR spectrum of succinized castor oil (sCO), itaconized castor oil (iCO) citraconized castor oil (cCO), and maleinized castor oil (mCO). Part of the itaconic anhydride becomes citraconic anhydride during the reaction. Therefore, in the product of the reaction between itaconic anhydride and castor oil it is possible to find peaks corresponding to the citraconized castor oil.

FIG. 5 shows the ¹H NMR spectrum of furan functionalized succinized castor oil (FsCO), furan functionalized itaconized castor oil (FiCO), furan functionalized citraconized castor oil (FcCO), and furan functionalized maleinized castor oil (FmCO).

FIG. 6 shows the mechanical properties of the undamaged materials. Stress-strain curves for a) furan-functionalized materials based on three anhydrides (FmCO, FICO, and FsCO) and DPBM, r=1; b) furan-functionalized itaconized castor oil (FiCO) reacted with DPBM at different furan/maleimide molar ratios; and c) furan-functionalized materials based on three anhydrides (FmCO, FICO, and FsCO) and liquid bismaleimide BMI-689, r=1.

FIG. 7 shows a) Dynamic rheometry results, between room temperature and 130° C., of furan-functionalized maleinized castor oil (FmCO) reacted with BMI-689, r=1; and b) DSC thermograms of furan-functionalized succinized castor oil (FsCO) reacted with 1,1′-(Methylenedi-4,1-phenylene)bismaleimide (DPBM) at different furan/maleimide molar ratios.

FIG. 8 shows a) Dynamic rheometry results, between 50 and 130° C., and b) a DSC thermogram, of furan functionalized epoxidized soybean oil (FACSO) reacted with BMI-689 according to Comparative example A.

FIG. 9 shows a DSC thermogram, of furan functionalized epoxidized soybean oil (sFASO) reacted with BMI-689 according to Comparative example B.

FIG. 10 shows self-healing of FsCO-DPBM r=0.8 over time.

FIG. 11 shows the mechanical and self-healing properties of the FmCO-DPBM r=0.8 material after 3 consecutive reprocessing cycles material before and after the reprocessing. On the left, the value obtained for the elongation or the Ultimate tensile stress, and on the right, its corresponding self-healing efficiency.

### DETAILED DESCRIPTION OF THE INVENTION

The present invention will now be further described. In the following paragraphs, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

When describing the compounds of the invention, the terms used are to be construed in accordance with the following definitions, unless a context dictates otherwise:

The term “alkyl” by itself, or as part of another substituent, refers to a fully saturated hydrocarbon of Formula CₓH₂ₓ or CₓH₂ₓ₊₁ wherein x is a number greater than or equal to 1. Generally, alkyl groups of this invention comprise from 1 to 20 carbon atoms. Alkyl groups may be linear or branched and may be substituted as indicated herein. When a subscript is used herein following a carbon atom, the subscript refers to the number of carbon atoms that the named group may contain. Thus, for example, C₁₋₄alkyl means an alkyl of one to four carbon atoms. Examples of alkyl groups are methyl, ethyl, n-propyl, i-propyl, butyl, and its isomers (e.g. n-butyl, i-butyl and t-butyl); pentyl and its isomers, hexyl and its isomers, heptyl and its isomers, octyl and its isomers, nonyl and its isomers; decyl and its isomers. C₁₋₆alkyl includes all linear, branched, or cyclic alkyl groups with between 1 and 6 carbon atoms, and thus includes methyl, ethyl, n-propyl, i-propyl, butyl and its isomers (e.g. n-butyl, i-butyl and t-butyl); pentyl and its isomers, hexyl and its isomers, cyclopentyl, 2-, 3-, or 4-methylcyclopentyl, cyclopentylmethylene, and cyclohexyl. An optionally substituted alkyl refers to an alkyl having optionally one or more substituents (for example 1, 2, 3 or 4).

The term “alkenyl” by itself, or as part of another substituent, refers to straight-chain, cyclic, or branched-chain hydrocarbon radicals containing at least one carbon-carbon double bond. Thus, for example, C₂₋₄alkenyl means an alkenyl of two to four carbon atoms. Examples of alkenyl radicals include ethenyl (vinyl), E- and Z-propenyl, allyl, isopropenyl, E- and Z-butenyl, E- and Z-isobutenyl, E- and Z-pentenyl, E- and Z-hexenyl, E,E-, E,Z-, Z,E-, Z,Z-hexadienyl, and the like. An optionally substituted alkenyl refers to an alkenyl having optionally one or more substituents (for example 1, 2, 3 or 4). C₁alkenyl refers to a vinyl moiety, where the C₁ substituent together with the carbon to which the substituent is connected, constitutes the carbon-carbon double bond.

Whenever used in the present invention the term “compounds of the invention” or a similar term is meant to include the compounds of general formula (I) and any subgroup thereof. This term also refers to their derivatives, such as solvates, hydrates, stereoisomeric forms, racemic mixtures, tautomeric forms, and optical isomers.

As used in the specification and the appended claims, the singular forms “a”, “an”, and “the” include plural referents unless the context clearly dictates otherwise. By way of example, “a compound” means one compound or more than one compound. The terms described above and others used in the specification are well understood to those in the art. The compounds of the present invention can be prepared according to the reaction scheme provided in the examples hereinafter, but those skilled in the art will appreciate that these are only illustrative for the invention and that the compounds of this invention can be prepared by any of several standard synthetic processes commonly used by those skilled in the art of organic chemistry.

According to a first aspect, the present invention provides a Diels-Alder-based polymer comprising the reaction product of a polymaleimide monomeric unit and a furan-functionalized prepolymer; wherein said furan-functionalized prepolymer is characterized in having a prepolymer backbone comprising a substituent having a central moiety according to formula (I)

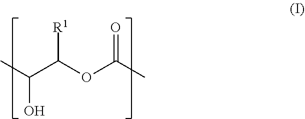

wherein R¹ is —H; wherein at least one furan-functionalized sidechain is connected to said central moiety; and wherein said prepolymer backbone is based on a polyester.

As mentioned herein and unless provided otherwise, the term “Diel-Alder-based polymer” should be understood as a polymer network containing reversible covalent crosslinks, formed by a Diels-Alder reaction between a furan and a maleimide, resulting in either isomer of the cycloadduct, referred to as “Diels-Alder bond”. The network structure is formed using two reactive moieties, being a furan-functionalized prepolymer and a polymaleimide, in particular a bismaleimide. The Diels-Alder reaction, forming said Diels-Alder bonds, is an equilibrium reaction making the formed crosslink bonds dynamic. Bonds are constantly broken and reformed in said dynamic network over time. However, a crosslink density can be defined for a specific temperature as long as this temperature remains unchanged.

In the event that Diels-Alder networks are damaged, Diels-Alder bonds and hydrogen bonding interactions are locally broken in a reversible fashion, resulting in active fracture surfaces. The hydrogen donors and acceptors and the newly formed furan and maleimide functional groups, resulting from the reversible mechanical breaking of the Diels-Alder bonds, autonomously reform the broken bonds, thus restoring the polymer network structure and related properties. The healing process is synergetically sped up by the presence of hydrogen bonds close to the Diels-Alder bonds. To effectuate healing of this damaged area, a first part of the self-healing process is bringing the fractured surfaces back into contact. Depending on the size of the damage, manual intervention or intervention by the robotic system might be necessary in order to actively push both fractured surfaces back together, for example when the material is cut all the way through, and two separate pieces are formed. Such full cuts require both fractured pieces to be pushed back together to initiate the healing process. In this case, it is of importance that both pieces are pushed back together as soon as possible after the damage occurred.

The fractured surfaces are brought back into contact as soon as possible, preferably within 1 to 2 hours after the damage occurred. Otherwise, the available reactive groups (maleimide and furan) will react with each other in the separate parts, resulting in a decrease of healing rate and efficiency for given healing conditions. Still, parts that are separated for longer times, can be healed with high efficiencies if the healing times are strongly increased or if the temperature is raised.

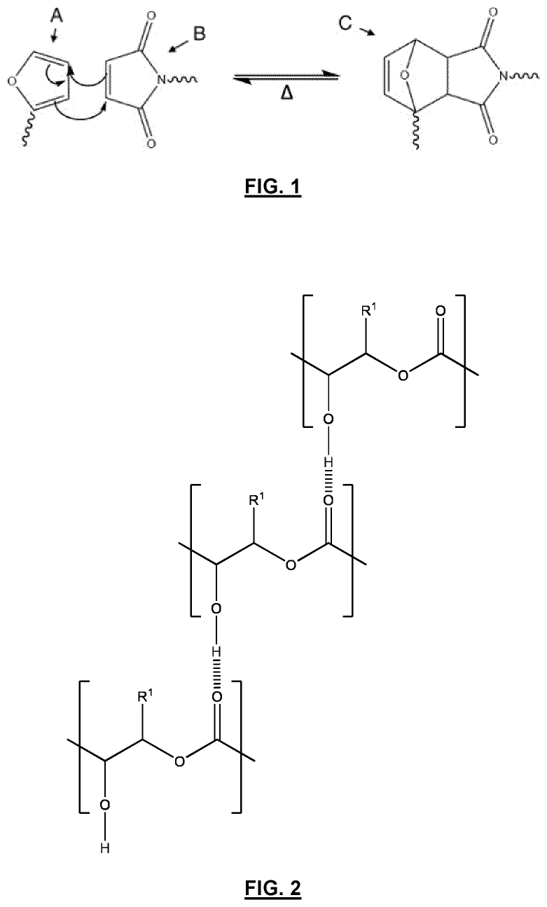

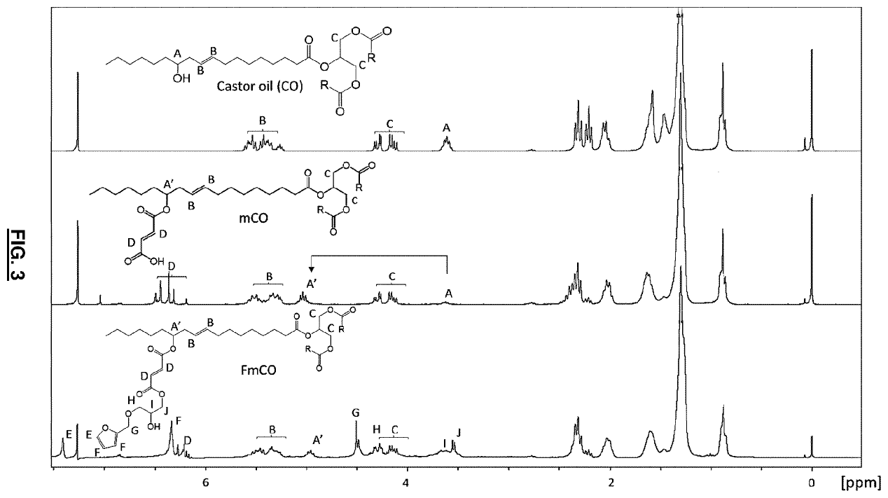

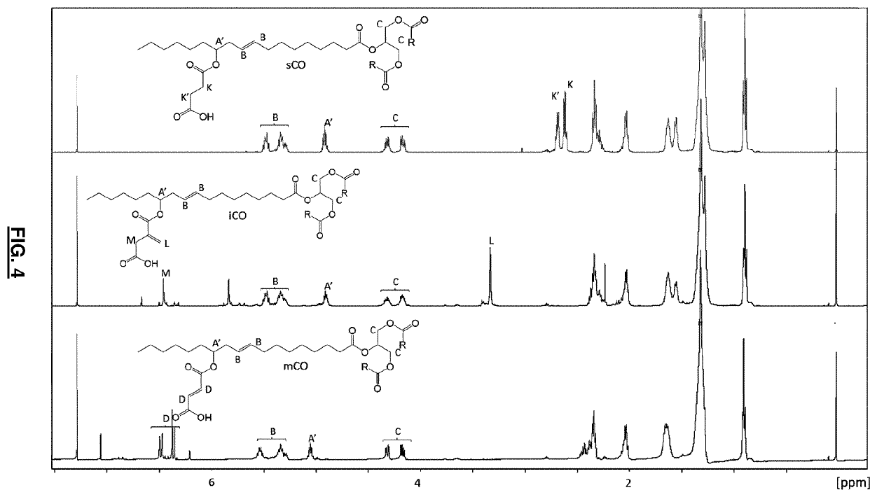

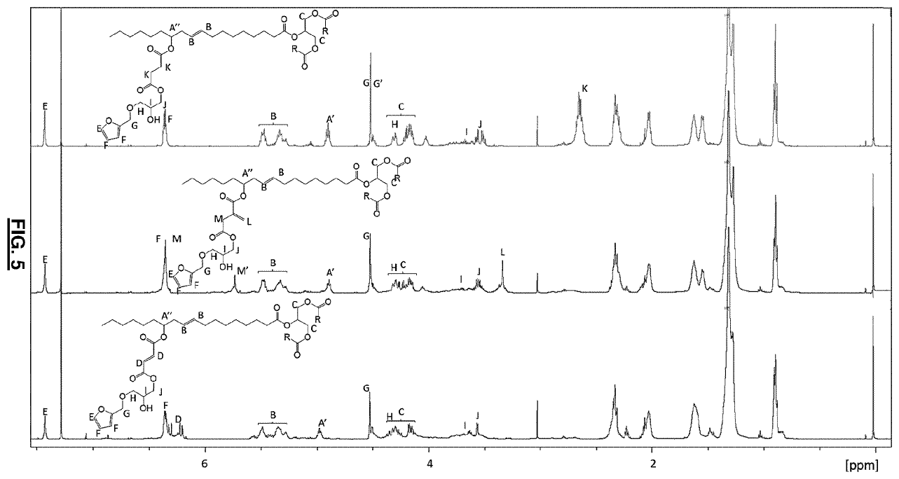

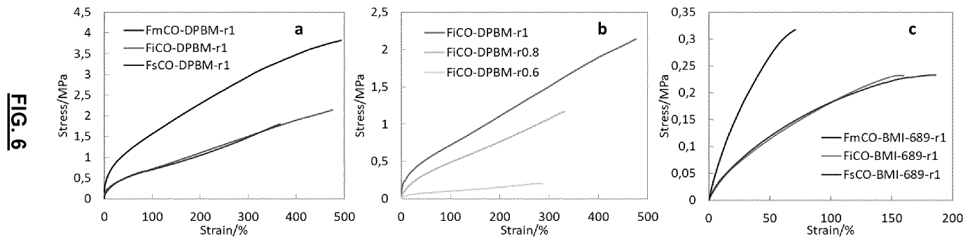

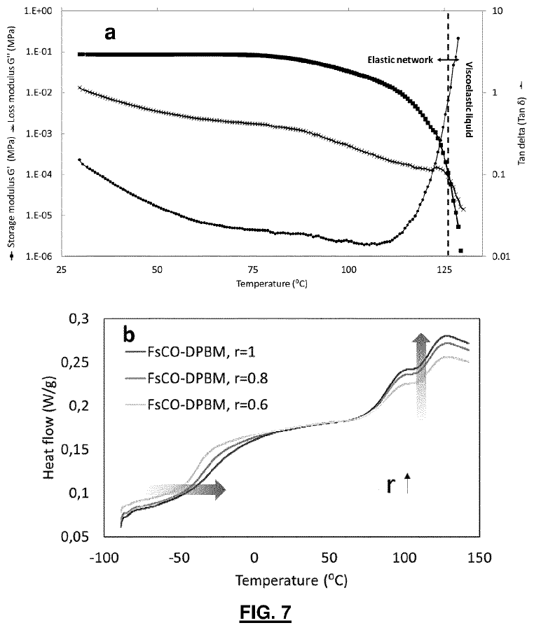

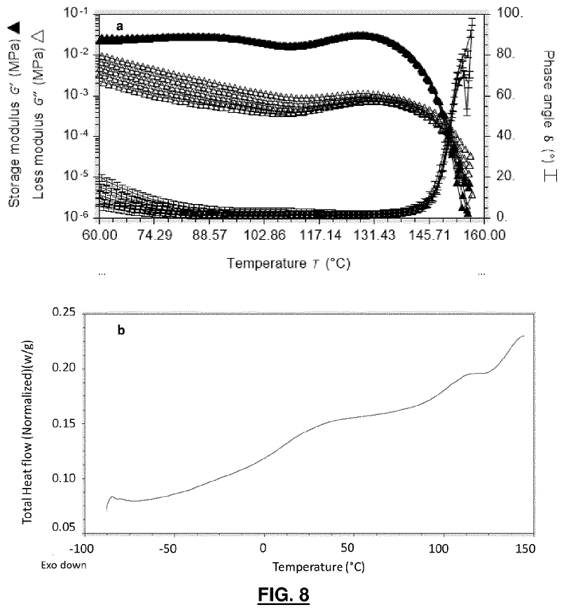

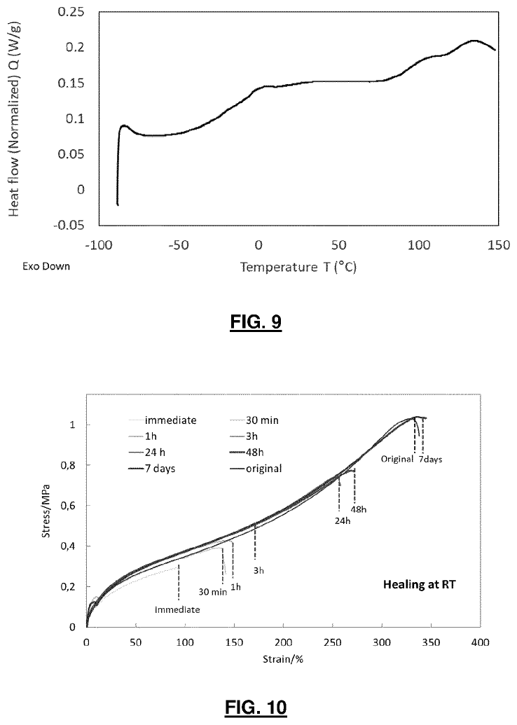

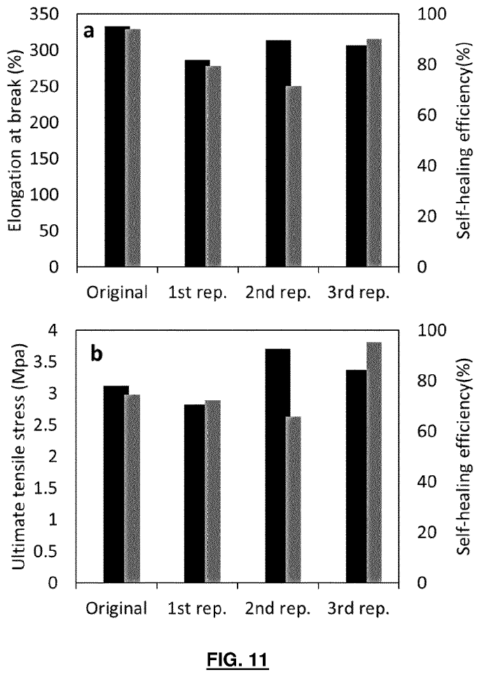

After the fractured surfaces are brought back together (autonomously or non-autonomously), the self-healing process is initiated. At this moment, a risk of microscopic misalignments and small cavities created in between said fractured surfaces exists. This is where the synergetic combination of weak hydrogen bond interactions and dynamic Diels-Alder covalent bonds (FIG. 1 and FIG. 2) of the present invention plays an essential role. On the one hand, when the material is damaged, the weak hydrogen bonds help in the immediate recovery of a fraction of the mechanical properties, guaranteeing a good contact and immediate adhesion when the cracked surfaces come in contact again. On the other hand, the Diels-Alder bonds are the main contributors to the mechanical properties and prevent, or reduce, creep.

The specific structure of the central moiety, which provides a hydrogen acceptor (carbonyl group) as well as a hydrogen donor (hydroxy group), is key to the self-healing properties of the current invention.

Owing to the reversible nature of the Diels-Alder and hydrogen bonds, the polymer network structure can be reversibly polymerized and depolymerized and, hence, the materials can be thermally processed, manufactured and recycled by way of common thermal and chemical processing methods.

As used herein and unless provided otherwise, the term “self-healing efficiency” should be understood as the recovery of a material property (e.g. mechanical strength) and measured by the ratio of the measured property after healing to the initial material property, being the property before damage. Healing efficiencies are for example based on mechanical moduli, mechanical strength, characterized by fracture stresses and fracture strains. Said efficiency may be expressed in percentages.

As used herein and unless provided otherwise, the concept of “autonomous self-healing” should be understood as the ability of self-healing materials (e.g. Diels-Alder-based polymers) to be healed when damaged, without the need for any external intervention of any kind (e.g. the need of increasing temperatures) once the fractured surfaces are brought in contact.

According to some embodiments of the invention, self-healing occurs at temperatures below 30, 29, 28, 27, 26, 25, 24, 23, 22, 21, 20, 19, 18, 17, 16, 15, 14, 13, 12, 11, 10, 5° C.

According to some embodiments of the invention, self-healing may occur at temperatures about and between 10, 15, 20° C. and 30, 40, 50° C., particular about and between 15, 20, 25° C. and 30, 35, 40° C. According to some embodiments of the invention, the increase of temperatures may improve the self-healing efficiency, but it remains a characteristic of the Diels-Alder-based polymer according to the invention that the self-healing process can occur at these lower ambient temperatures.

According to some embodiments of the invention, self-healing efficiencies of about 80, 90, 100%, in particular of about 90, 95, 99% may be achieved at room temperature. Self-healing efficiencies of about 70, 80% are already realized after about 1 to 2 days at about 25° C. Self-healing efficiencies of about 96, 97, 98% are already realized after about 7 days at about 25° C. It should be noted that a healing efficiency of 100% means that the full mechanical and fracture properties of the material are recovered, while the properties required for the application may be recovered at much shorter times.

It is an advantage of the current invention that the Diels-Alder-based polymer comprises both the necessary chain mobility in the network and reactive components (Diels-Alder bonds and hydrogen bonds) of sufficient concentration to heal macroscopic damage at room temperature with high healing efficiency at considerable rate.

According to some embodiments of the invention, healing times may range from minutes to hours to days, more specifically from about 1, 2, 3, 4, 5, 10, 15, 20, 30, 40, 50, 60 minutes to about 1, 2, 3, 4, 5, 6, 7, 8, 9, 10, 15, 20, 30 days. Besides the temperature, also the time of self-healing will influence the healing efficiency. The longer one allows the damaged material to repair itself (i.e. keeping the fracture surfaces in good contact), the higher the healing efficiency at a given temperature will be. Among other things, aspects such as the maleimide-to-furan ratio, the available reactive groups, flexibility of the monomer units, the crosslink density, the molecular mobility, the healing temperature and the time between the fracture and the contact of the fracture surfaces may influence the healing times which are required to achieve a certain amount of healing efficiency. According to some embodiments of the invention, healing times may be reduced by elevating healing temperatures. However, it is an advantage of embodiments of the current invention that healing may occur at room temperature and even below room temperature.

According to some embodiments of the invention, the damage surface of the Diels-Alder-based polymer may be completely recovered in that the initial strength of the Diels-Alder-based polymer is completely regained. Per reference to the examples hereinafter, such complete recovery wherein the initial strength of the Diels-Alder-based polymer is completely regained, was in particular found to occur in case of realignment of the fractured surfaces when brought in contact with one another.

The prepolymer backbone of said furan-functionalized prepolymer could be based on any suitable polyester. Examples of such suitable polyesters are naturally occurring fatty acid esters or condensation products of fatty acids, or mixtures thereof, with aliphatic polyols. Said polyols could be for instance selected from 1,2-ethanediol, 1,2-propanediol, 1,3-propanediol, 1,2-butanediol, 1,3-butanediol, 2,3-butanediol, 1,5-pentanediol, neopentylglycol, 1,6-hexanediol, glycerol, trimethylolpropane, pentaerythritol and dipentaerythritol. Said fatty acids could be for instance selected from unsaturated fatty acids, such as oleic acid, linoleic acid and linolenic acid, or hydroxy fatty acids, such as 12-hydroxystearic acid, 12-hydroxyoctadec-9-enoic acid and 14-hydroxyicos-11-enoic acid. Other examples of suitable polyesters are condensation products of aliphatic or aromatic polyols with aliphatic or aromatic polycarboxylic acids, condensation products of hydroxy fatty acids or polyesters obtained by other means of polymerization, such as, but not limited to, ring-opening polymerization of lactones.

According to an embodiment of the invention, said furan-functionalized sidechain is directly connected to said central moiety, and has a structure according to formula (II)

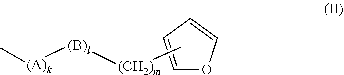

wherein
A is selected from —C₁₋₆alkyl-, —C₂₋₆alkenyl-, and —C₁₋₆alkyl-O—; wherein each of said —C₁₋₆alkyl-, —C₂₋₆alkenyl-, and —C₁₋₆alkyl-O— is optionally and independently substituted with from 1 to 3 substituents selected from -halo, —OH, —C₁₋₆alkyl, —C₁₋₆alkenyl, and —O—C₁₋₆alkyl;
B is selected from —C(O)O—, and —O(O)C—;
k is an integer selected from: 0, 1, 2;
l is an integer selected from: 0, 1; and
m is an integer selected from: 0, 1, 2, 3, 4, 5.

According to an embodiment of the invention, said central moiety of formula (I) is directly connected to the prepolymer backbone.

According to an embodiment of the invention, said central moiety of formula (I) is connected to the prepolymer backbone through a linker structure according to formula (III)

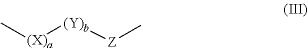

wherein
X is selected from —C₁₋₆alkyl-, and —C₂₋₆alkenyl-; wherein each of said —C₁₋₆alkyl-, and —C₂₋₆alkenyl- is optionally and independently substituted with from 1 to 3 substituents selected from-halo, —OH, —C₁₋₆alkyl, —C₁₋₆alkenyl and —O—C₁₋₆alkyl;
Y is selected from —C(O)O—, and —O(O)C—;
Z is selected from —O—, and —C(O)O—;
a is an integer selected from: 0, 1, 2; and
b is an integer selected from: 0, 1.

According to a particular embodiment of the invention, a Diels-Alder-based polymer is provided comprising the reaction product of a polymaleimide monomeric unit and a furan-functionalized prepolymer;

Wherein said furan-functionalized prepolymer is characterized in having a prepolymer backbone comprising a substituent having a central moiety according to formula (I);

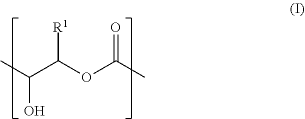

wherein R¹ is —H; wherein at least one furan-functionalized sidechain is directly connected to said central moiety; and wherein said prepolymer backbone is based on a polyester;
wherein at least one furan-functionalized sidechain, according to formula (II), is directly connected to said central moiety of formula (I);

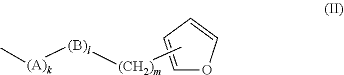

wherein A is selected from —C₁₋₆alkyl-, —C₂₋₆alkenyl-, and —C₁₋₆alkyl-O—; wherein each of said —C₁₋₆alkyl-, —C₂₋₆alkenyl-, and —C₁₋₆alkyl-O-is optionally and independently substituted with from 1 to 3 substituents selected from -halo, —OH, —C₁₋₆alkyl, —C₁₋₆alkenyl, and —O—C₁₋₆alkyl;
B is selected from —C(O)O—, and —O(O)C—;
k is an integer selected from: 0, 1, 2;
l is an integer selected from: 0, 1; and
m is an integer selected from: 0, 1, 2, 3, 4, 5.

According to another particular embodiment of the invention, a Diels-Alder-based polymer is provided comprising the reaction product of a polymaleimide monomeric unit and a furan-functionalized prepolymer;
wherein said furan-functionalized prepolymer is characterized in having a prepolymer backbone comprising a substituent having a central moiety according to formula (I);

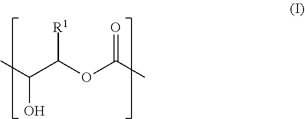

wherein R¹ is —H; wherein at least one furan-functionalized sidechain is connected to said central moiety; and wherein said prepolymer backbone is based on a polyester;
wherein at least one furan-functionalized sidechain, according to formula (II), is directly connected to said central moiety;

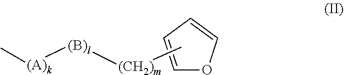

wherein A is selected from —C₁₋₆alkyl-, —C₂₋₆alkenyl-, and —C₁₋₆alkyl-O—; wherein each of said —C₁₋₆alkyl, —C₂₋₆alkenyl-, and —C₁₋₆alkyl-O— s optionally and independently substituted with from 1 to 3 substituents selected from -halo, —OH, —C₁₋₆alkyl, —C₁₋₆alkenyl, and —O—C₁₋₆alkyl;
B is selected from —C(O)O—, and —O(O)C—;
k is an integer selected from: 0, 1, 2;
l is an integer selected from: 0, 1;
m is an integer selected from: 0, 1, 2, 3, 4, 5; and
wherein
said central moiety is connected to the prepolymer backbone through a linker structure according to formula (III)

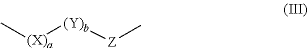

wherein X is selected from —C₁₋₆alkyl-, and —C₂₋₆alkenyl-; wherein each of said —C₁₋₆alkyl-, and —C₂₋₆alkenyl-is optionally and independently substituted with from 1 to 3 substituents selected from -halo, —OH, —C₁₋₆alkyl, —C₁₋₆alkenyl and —O—C₁₋₆alkyl;
Y is selected from —C(O)O—, and —O(O)C—;
Z is selected from —O—, and —C(O)O—;
a is an integer selected from: 0, 1, 2; and
b is an integer selected from: 0, 1.

Scheme 1 provides a reaction scheme for the preparation of a Diels-Alder-based polymer according to a particular embodiment of the invention, starting from castor oil (CO) and itaconic anhydride (IA), further reaction with furfuryl glycidyl ether (FGE) and finally crosslinking with DPBM.

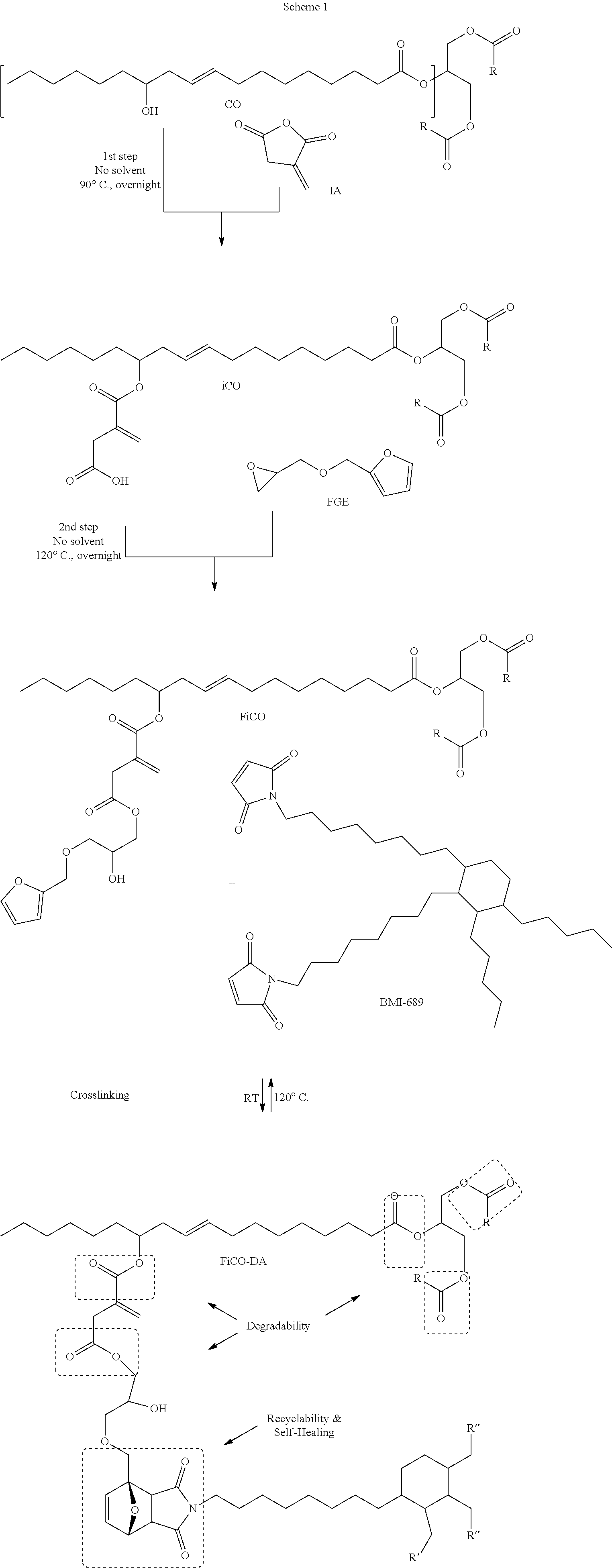

According to an embodiment of the invention, said polymaleimide monomeric unit and said furan-functionalized prepolymer both comprise a functionality of at least 2, and wherein the sum of the functionalities of both said polymaleimide monomeric unit and said furan-functionalized prepolymer is at least 4.6.

Unless provided otherwise, the functionality should be understood as the number of maleimide groups or furan groups on the polymaleimide monomeric units and the furan-functionalized prepolymers, respectively.

According to an embodiment of the invention, the maleimide-to-furan stoichiometric ratio between said polymaleimide monomeric unit and said furan-functionalized prepolymer ranges from 1 to 0.25, preferably from 1 to 0.6.

Unless provided otherwise, the maleimide-to-furan stoichiometric ratio (r) should be understood as the molar ratio of maleimide groups to furan groups.

According to an embodiment of the invention, said polymaleimide is selected from the list comprising 1,1′-(methylenedi-4,1-phenylene) bismaleimide (DPBM), N,N′-(1,4-phenylene) dimaleimide, N,N′-(1,3-phenylene)dimaleimide, bismaleimide, Homide 122G, Homide 116, BMI-689, BMI-1400, BMI-1700 and the like.

According to another aspect, the present invention provides a composition comprising a Diels-Alder-based polymer as defined herein.

According to some embodiments of the invention, said composition further comprises a radical scavenger. According to a particular embodiment of the invention, said radical scavenger is selected from the list comprising hydroquinone butylated hydroxytoluene, 4-tert-butylcatechol, methyl-p-benzoquinone, and the like. According to some embodiments of the invention, said composition may further comprise additives, said additives adding functionality or characteristics such as color, texture, tactile experience, flexibility, processability, viscosity at higher temperatures, electrical or magnetic properties and the like to the reaction product.

According to another aspect, the present invention provides a method of preparing a Diels-Alder-based polymer as defined herein, said method comprising the step of preparing a composition comprising a polymaleimide monomeric unit and a furan-functionalized prepolymer.

According to yet another aspect, the present invention provides uses of Diels-Alder-based polymers or compositions of the present invention.

According to a further embodiment, the present invention provides the use of Diels-Alder-based polymers or compositions, as self-healing material.

According to a further embodiment, the present invention provides the use of Diels-Alder-based polymers or compositions, in robotics or biomedicine.

According to some embodiments of the invention, the use in robotics may constitute the subfield of soft robotics. As used herein and unless provided otherwise, the term “soft robotics” should be understood as a subfield of robotics covering the construction of robotic parts and robots from different types of materials approaching the properties of those found in living organisms. These materials often require a certain amount of flexibility and adaptability depending on their specific purpose.

As previously mentioned, an example of robotic systems is the manufacturing of soft robotic system such as soft grippers which can be used in agriculture, e.g. for picking fruit. In these circumstances, the materials of these soft grippers should allow the handling of delicate fruits (e.g. strawberries) without damaging said fruits. In these circumstances, however, it is unavoidable that these soft grippers are damaged, e.g., by sharp twigs and thorns. This is only one example where the specific characteristics of self-healing Diels-Alder-based polymers offer great advantages when being applied in the field of robotics.

According to some embodiments of the invention, said soft robotic actuators may comprise several bending soft pneumatic actuators (BSPA). Together, these BSPAs may be used more particularly as finger-like structures of said soft robotic systems, such as soft grippers. The bendability thereof allows movement of said finger-like structures mimicking human-like hand gestures.

According to a further embodiment, the present invention provides the use of Diels-Alder-based polymers or compositions, in the manufacturing of 1D, 2D or 3D structures, more particular in the manufacturing of robotic components.

According to a further embodiment, the present invention provides the use of Diels-Alder-based polymers or compositions, in filament extrusion, extrusion-based printing techniques, selective laser sintering, injection molding, compression molding, casting, soft lithography, and the like. According to a particular embodiment of the invention, said extrusion-based printing techniques are selected from the list comprising fused filament fabrication, direct ink writing, and the like.

According to another aspect, the present invention provides a 1D, 2D or 3D structure comprising Diels-Alder-based polymers or compositions, as defined herein.

The compounds of the present invention can be prepared according to the method(s) provided in the examples hereinafter, but those skilled in the art will appreciate that these are only illustrative for the invention and that the compounds of this invention can be prepared by any of several standard synthetic processes commonly used by those skilled in the art of organic chemistry.

As described herein before, the self-healing characteristics of the Diels-Alder-polymers are based on the reversible crosslinking reaction between the furan-functionalized prepolymer according to formula (I) with a polymaleimide. FIG. 1 shows the reversible Diels-Alder reaction scheme between a furan A and maleimide B group resulting in a Diels-Alder reaction product C. The reversible Diels-Alder polymer network is based on a reversible Diels-Alder reaction between the functional furan A and maleimide group B, resulting in a strong covalent bond that can be thermally or mechanically broken and reformed in a reversible fashion, effectuating the self-healing characteristics.

### EXAMPLES

### Materials

Succinic anhydride (SA), Itaconic anhydride (IA), Maleic anhydride (MA), Castor oil (CO; 164 mg KOH/g), furfuryl alcohol (FA), 3-furoic acid (FAc) and 1,1′-(methylenedi-4,1-phenylene) bismaleimide (DPBM) were obtained from Sigma Aldrich. 4-tert-butylcatechol was used as a radical inhibitor and was obtained by Sigma Aldrich. Furfuryl glycidyl ether (FGE) was obtained from Sage Chemicals (Hangzhou, China). Epoxidized soybean oil (SO) was obtained from Varteco (Santa Fe, Argentina). BMI-689 was obtained from Designer molecules (Willow Creek, San Diego). All products were used as received.

### Analysis

¹H NMR was performed on a Bruker Avance DRX 250 with an opening frequency of 250 MHZ. The analysis was performed at room temperature using CDCl₃ as a solvent and TMS as internal standard. The measured samples had a concentration of 10 mg m⁻¹.

Fourier transform infrared (FTIR) spectroscopy was performed on a Nicolet 6700 FTIR spectrometer from Thermo Scientific at ambient temperature, using OMNIC as a software package. All spectra are averaged from 32 scans, which are recorded between 4000 cm⁻¹ and 600 cm⁻¹.

GPC analysis was performed on a Shimadzu system using a combination of a Styragel HR0.5 and HR1 column connected to a RID and UV detector. The instrument was calibrated with a polystyrene internal standard and eluted with tetrahydrofuran (THF).

Differential scanning calorimetry (DSC) was performed on a TA Instruments Discovery DSC equipped with a refrigerated cooling system (RCS). All the experiments were performed in Tzero aluminum pans in hermetic conditions, using nitrogen as purge gas and a heating/cooling rate of 5° C. min⁻¹.

Dynamic mechanical analysis (DMA) was performed on a TA Instruments DMA Q800 equipped with a nitrogen gas cooling accessory. Stress-strain tensile tests were performed at room temperature using a film tension clamp. Rectangular specimens with a thickness of 1.25 mm and 5 mm width were clamped with a distance between clamps of 5 mm and strained at a rate of 60% min⁻¹. The Young's modulus was determined in the initial linear region of the stress-strain curve (0-1% strain). To study the viscoelastic properties the samples were subjected to small amplitude oscillatory measurements at a frequency of 1 Hz and 0.1% strain in heat-cool cycles at a rate of 2° C. min⁻¹ between −80° C. and 90° C.

Dynamic rheometry was performed with a TA instrument Discovery Hybrid Rheometer (DHR2). The samples were cut into circles and put in between 10 mm diameter aluminum parallels plates. The samples were subjected to an oscillatory strain of 5% at different frequencies: 0.312, 0.562, 1.0, 1.778, and 3.125 Hz. At the same time a temperature ramp between 40° C. and 120° C. to determine the gelation transition temperature.

To perform an accelerated in vitro degradation test, 3 squares of 10 mm×10 mm×1.25 mm were cut for each sample and placed into a KCI NaOH buffer solution set to a pH of 13 and a temperature of 37° C. for 14 days. The samples were dried and weighed every day and the mass loss was measured.

### Synthesis

### Example 1

Ring-opening esterification was performed on castor oil using maleic anhydride (MA). The reaction was performed under an N₂ atmosphere, without solvent and magnetically stirred. A molar proportion of 1:1 between the hydroxyl groups from the castor oil and the anhydride was used. The esterification reaction was performed at 100° C. for 24 h. The resulting maleinized castor oil (mCO) was used without any further purification.

### Example 2

Ring-opening esterification was performed on castor oil using itaconic anhydride (IA). The reaction was performed under an N₂ atmosphere, without solvent and magnetically stirred. A molar proportion of 1:1 between the hydroxyl groups from the castor oil and the anhydride was used. The esterification reaction was performed at 100° C. for 24 h. The resulting itaconized castor oil (iCO) was used without any further purification.

### Example 3

Ring-opening esterification was performed on castor oil using succinic anhydride (SA). The reaction was performed under an N₂ atmosphere, without solvent and magnetically stirred. A molar proportion of 1:1 between the hydroxyl groups from the castor oil and the anhydride was used. The esterification reaction was performed at 130° C. for 24 h. The resulting succinized castor oil (sCO) was used without any further purification.

### Example 4

Furfuryl glycidyl ether (FGE) was directly mixed with the mCO with a molar proportion of 1:1 with respect to the anhydride. The reaction was performed under a N₂ atmosphere, without solvent and magnetically stirred. The functionalization was done at 120° C. overnight. The resulting furan functionalized maleinized castor oil (FmCO) was used in the following steps without any further purification.

### Example 5

Furfuryl glycidyl ether (FGE) was directly mixed with the iCO with a molar proportion of 1:1 with respect to the anhydride. The reaction was performed under a N₂ atmosphere, without solvent and magnetically stirred. The functionalization was done at 120° C. overnight. The resulting furan functionalized itaconized castor oil (FiCO) was used in the following steps without any further purification.

### Example 6

Furfuryl glycidyl ether (FGE) was directly mixed with the sCO with a molar proportion of 1:1 with respect to the anhydride. The reaction was performed under a N₂ atmosphere, without solvent and magnetically stirred. The functionalization was done at 120° C. overnight. The resulting furan functionalized succinized castor oil (FsCO) was used in the following steps without any further purification.

### Example 7

FmCO, FICO and FsCO were crosslinked using two different bismaleimides, being 1,1′-(Methylenedi-4,1-phenylene) bismaleimide (DPBM) and a commercial low viscosity bismaleimide (BMI-689) derived from fatty acids.

For the preparation of the networks crosslinked with DPBM, the functionalized castor oil samples were placed in separate beakers and DPBM was added to the mixtures, 3 different molar ratios between furan and maleimide groups were prepared for each functionalized oil (1:1, 1:0.8, 1:0.6). Finally, 1 wt. % of 4-tertbutylcatechol was added to prevent radical side reactions between the maleimide groups. The mixture was heated up until the DPBM melted and formed a homogeneous solution with the functionalized oils. Subsequently, the homogenous solutions were poured into square PTFE molds. The samples could be demolded 2 h after and the final mechanical properties of the material were obtained after 24 h curing at room temperature.

The samples crosslinked with BMI-689 were prepared by simply mixing the functionalized oils with the BMI-689 at least 24 h at room temperature.

### Comparative Example A

3-Furoic acid was directly mixed with epoxidized soybean oil with a molar proportion of 1:1 with respect to the epoxy rings of the epoxidized soybean oil. The reaction was performed under a N₂ atmosphere, without solvent and magnetically stirred. The functionalization was done at 120° C. overnight. The resulting furan functionalized epoxidized soybean oil (FACSO) was used in the following steps without any further purification.

The furan functionalized epoxidized soybean oil (FACSO) was mixed with BMI-689 bismaleimide in a ratio of 70 wt. % of the furan functionalized epoxidized soybean oil and 30 wt. % of BMI-689. The mixture was left to react for two days at room temperature. After the reaction, the mixture became a solid elastic material.

### Comparative Example B

Furfuryl alcohol (FA) was mixed with succinic anhydride (SA) with a molar proportion of 1:1 with respect to the anhydride. The reaction was performed overnight at 50° C. at ambient conditions. The resulting succinized furfuryl alcohol (sFA) was used in the following steps without any further purification.

The succinized furfuryl alcohol (sFA) was mixed with epoxidized soybean oil with a proportion of 1:1 with respect to the epoxy rings of the oil. The mixture was reacted at 120° C. overnight under N₂ atmosphere, without solvent and magnetically stirred. The resulting furan functionalized epoxidized soybean oil (sFASO) was used in the following steps without any further purification.

The resulting furan functionalized epoxidized soybean oil (sFASO) was crosslinked using two different bismaleimides, being 1,1′-(Methylenedi-4,1-phenylene)bismaleimide (DPBM) and (BMI-689) bismaleimide.

For the preparation of the network crosslinked with DPBM, sFASO was mixed with DPBM with a molar proportion of 1:1 between furan and maleimides groups. The mixture was reacted a 150° C. under stirring and poured into a mould. After cooling down, the material became an elastic solid.

For the preparation of the network crosslinked with BMI-689, sFASO was mixed with the bismaleimide in a ratio of 70 wt. % of the furan functionalized epoxidized soybean oil and 30 wt. % of BMI-689. The mixture was let to react for two days at room temperature. After the reaction, the mixture became a solid elastic material.

### Mechanical Properties & Self-Healing Efficiencies

Comparison of the mechanical properties and self-healing efficiencies of twelve different materials, as prepared in Example 7, are shown in Table 1. The materials were synthesized using three different cyclic anhydrides (maleic, itaconic and succinic), crosslinked with two different bismaleimides (DPBM, and BMI-689), and three different furan/maleimide stoichiometric ratios.

| | | | Ultimate tensile | Elongation at | Self-healing | η E | η Ultimate tensile | η elongation at |
|---|---|---|---|---|---|---|---|---|
| Sample | | E (MPa) | strength (MPa) | break (%) | conditions | (%) | strength (%) | break (%) |
| FmCO-DPBM | r = 1 | 20 ± 5 | 3.45 ± 0.42 | 487 ± 17 | 80° C., 30 min | 89 | 83 | 86 |
| | | | | | RT, 24 h | 80 | 15 | 15 |
| | r = 0.8 | 7 ± 2 | 2.90 ± 0.31 | 427 ± 55 | 80° C., 30 min | 100 | 94 | 75 |
| | | | | | RT, 24 h | 97 | 6 | 16 |
| | r = 0.6 | 2.3 ± 0.4 | 1.16 ± 0.12 | 270 ± 31 | 80° C., 30 min | 98 | 96 | 86 |
| | | | | | RT, 24 h | 100 | 36 | 25 |
| FiCO-DPBM | r = 1 | 6.97 ± 0.75 | 2.00 ± 0.14 | 446 ± 35 | 70° C., 30 min | 102 | 77 | 77 |
| | | | | | RT, 24 h | 72 | 39 | 35 |
| | r = 0.8 | 3.7 ± 0.3 | 1.36 ± 0.18 | 335 ± 63 | 70° C., 30 min | 102 | 113 | 118 |
| | | | | | RT, 24 h | 104 | 52 | 37 |
| | r = 0.6 | 0.6 ± 0.2 | 0.19 ± 0.02 | 281 ± 10 | 70° C., 30 min | 135 | 80 | 91 |
| | | | | | RT, 24 h | 98 | 78 | 85 |
| FsCO-DPBM | r = 1 | 6.4 ± 0.5 | 1.81 ± 0.22 | 371 ± 55 | 70° C., 30 min | 71 | 93 | 109 |
| | | | | | RT, 72 h | 108 | 70 | 68 |
| | | | | | RT, 144 h | 112 | 89 | 100 |
| | r = 0.8 | 2.2 ± 0.2 | 0.94 ± 0.03 | 324 ± 12 | RT, 24 h | 113 | 71 | 76 |
| | | | | | RT, 48 h | 103 | 77 | 82 |
| | | | | | RT, 144 h | 120 | 106 | 99 |
| | r = 0.6 | No network formation | | | | | | |
| FmCO-BMI-689 | r = 1 | 0.9 ± 0.1 | 0.31 ± 0.06 | 86 ± 24 | 60° C., 1 h | 105 | 93 | 81 |
| | | | | | RT, 72 h | 108 | 79 | 64 |
| FiCO-BMI-689 | r = 1 | 0.5 ± 0.1 | 0.21 ± 0.03 | 166 ± 8 | 70° C., 30 min | 93 | 92 | 94 |
| | | | | | RT, 24 h | 66 | 36 | 32 |
| FsCO-BMI-689 | r = 1 | 0.5 ± 0.1 | 0.26 ± 0.05 | 202 ± 19 | RT, 24 h | 63 | 67 | 67 |

### Preparation of the Soft Robotic Grippers

The soft robotic grippers were prepared by moid casting of the self-healing materials. The molds were obtained by 3D printing using a Prusa SL1 Stereolithography (SLA) printer with 3DM-HTR140 resin. The gripper consisted of 8 different parts that were joined together using a soldering iron at 150° C. to apply local heat at the joint.

1. A Diels-Alder-based polymer comprising the reaction product of a polymaleimide monomeric unit and a furan-functionalized prepolymer;
wherein said furan-functionalized prepolymer is characterized in having a prepolymer backbone comprising a substituent having a central moiety according to formula (I) 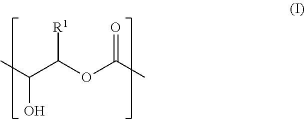
wherein R¹ is —H; wherein at least one furan-functionalized sidechain is connected to said central moiety; and wherein said prepolymer backbone is based on a polyester.

2. The Diels-Alder-based polymer according to claim 1, wherein said furan-functionalized sidechain is directly connected to said central moiety, and has a structure according to formula (II) 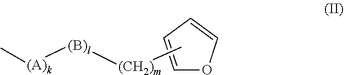
wherein
A is selected from —C₁₋₆alkyl-, —C₂₋₆alkenyl-, and —C₁₋₆alkyl-O—; wherein each of said —C₁₋₆alkyl-, —C₂₋₆alkenyl-, and —C₁₋₆alkyl-O— is optionally and independently substituted with from 1 to 3 substituents selected from -halo, —OH, —C₁₋₆alkyl, —C₁₋₆alkenyl, and —O—C₁₋₆alkyl;
B is selected from —C(O)O—, and —O(O)C—;
k is an integer selected from: 0, 1, 2;
l is an integer selected from: 0, 1; and
m is an integer selected from: 0, 1, 2, 3, 4, 5.

3. The Diels-Alder-based polymer according to any one of claims 1 to 2, wherein the central moiety of formula (I) is directly connected to the prepolymer backbone.

4. The Diels-Alder-based polymer according to claim 3, wherein the central moiety of formula (I) is connected to the prepolymer backbone through a linker structure according to formula (III) 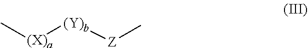
wherein
X is selected from —C₁₋₆alkyl-, and —C₂₋₆alkenyl-; wherein each of said —C₁₋₆alkyl-, and —C₂₋₆alkenyl- is optionally and independently substituted with from 1 to 3 substituents selected from -halo, —OH, —C₁₋₆alkyl, —C₁₋₆alkenyl and —O—C₁₋₆alkyl;
Y is selected from —C(O)O—, and —O(O)C—;
Z is selected from —O—, and —C(O)O—;
a is an integer selected from: 0, 1, 2; and
b is an integer selected from: 0, 1.

5. The Diels-Alder-based polymer according to any one of claims 1 to 4, wherein said polymaleimide monomeric unit and said furan-functionalized prepolymer both comprise a functionality of at least 2, and wherein the sum of the functionalities of both said polymaleimide monomeric unit and said furan-functionalized prepolymer is at least 4.6.

6. The Diels-Alder-based polymer according to any one of claims 1 to 4, wherein the maleimide-to-furan stoichiometric ratio between said polymaleimide monomeric unit and said furan-functionalized prepolymer ranges from 1 to 0.25.

7. The Diels-Alder-based polymer according to any one of claims 1 to 4, wherein the maleimide-to-furan stoichiometric ratio between said polymaleimide monomeric unit and said furan-functionalized prepolymer ranges from 1 to 0.6.

8. The Diels-Alder-based polymer according to any one of claims 1 to 7, wherein the polymaleimide is selected from the list comprising: 1,1′-(methylenedi-4,1-phenylene)bismaleimide, N,N′-(1,4-phenylene)dimaleimide, N,N′-(1,3-phenylene)dimaleimide and bismaleimide.

9. A composition comprising a polymer as defined in any one of claims 1 to 8.

10. The composition according to claim 9, further comprising a radical scavenger.

11. The composition according to claim 10, wherein the radical scavenger is selected from the list comprising: hydroquinone butylated hydroxytoluene, 4-tert-butylcatechol, methyl-p-benzoquinone.

12. A method of preparing a Diels-Alder-based polymer, said method comprising the step of preparing a composition comprising a polymaleimide monomeric unit and a furan-functionalized prepolymer as defined in any one of claims 1 to 4.

13. Use of the Diels-Alder-based polymer as defined in anyone of claims 1 to 8; or the composition as defined in claims 9 to 11 as self-healing material.

14. Use of the Diels-Alder-based polymer as defined in anyone of claims 1 to 8; or the composition as defined in claims 9 to 11 in robotics or biomedicine.

15. Use of the Diels-Alder-based polymer as defined in anyone of claims 1 to 8; or the composition as defined in claims 9 to 11 in the manufacturing of 1D, 2D or 3D structures.

16. Use of the Diels-Alder-based polymer as defined in anyone of claims 1 to 8; or the composition as defined in claims 9 to 11 in the manufacturing of robotic components.

17. Use of the Diels-Alder-based polymer as defined in anyone of claims 1 to 8; or the composition as defined in claims 9 to 11 in a manufacturing method selected from the list comprising: filament extrusion, extrusion-based printing techniques, selective laser sintering, injection molding, compression molding, casting, soft lithography.

18. Use as defined in claim 17, wherein said extrusion-based printing techniques are selected from the list comprising: fused filament fabrication, direct ink writing.

19. A 1D, 2D or 3D structure comprising the Diels-Alder-based polymer as defined in anyone of claims 1 to 8; or the composition as defined in claims 9 to 11.
